(19) United States
(12) Patent Application Publication
(10) Pub. No.: US 2015/0049873 A1
(43) Pub. Date: Feb. 19, 2015

(54) Sound Activated Music Accessory Device

(71) Applicant: Jonathan Blake Buller, Temecula, CA (US)

(72) Inventor: Jonathan Blake Buller, Temecula, CA (US)

(21) Appl. No.: 14/454,640

(22) Filed: Aug. 7, 2014

Related U.S. Application Data
(60) Provisional application No. 61/866,625, filed on Aug. 16, 2013.

(51) Int. Cl. H04R 29/00; A63H 3/28

(52) U.S. Cl. CPC H04R 29/00; A63H 3/28
USPC 381/56

(57) ABSTRACT

Improvements in a sound activated music accessory device are disclosed where the accessory device further enhances the listening experience by providing an interaction device. The device can be an item that is seen in the movie or music video and can be included with the CD/DVD or can be sold as a separate item. The activation and or deactivation are synchronized with the embedded sound that is placed into the soundtrack. The sound, tone, frequency or complex blended sound or sounds are subtle or non-obvious to a person listening to the music but are detected by the accessory device to begin a sequence or stop a sequence to correspond the a particular part of the soundtrack. The activation can mimic what is occurring in a movie, video or soundtrack. The accessory device to be a bracelet, necklace, hat, headband, apparel, plush or rigid toy.

### CROSS REFERENCE TO RELATED APPLICATIONS

This application claims the benefit of Provisional Application Ser. No. 61/866,625 filed Aug. 16, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a sound activated music accessory device. More particularly, the present device is provided with a music or movie soundtrack and tones or music patterns activate and deactivate an accessory device such as a bracelet, necklace or toy.

2. Description of Related Art Including Information Disclosed Under 37 CFR 1.97 and 1.98

Movies and music are typically played or viewed. The extent of the entertainment is with the visual and or audible enjoyment from a TV, audio player or other viewing or listening device. Separate from the screen and listening enjoyment there is limited interaction for a person that viewing and or listening. To further the viewing and listening of a movie or sound track there are limited products that can provide additional enjoyment to the experience.

A number of patents and or publications have been made to increase the viewing and or listening enjoyment for a person. Exemplary examples of patents and or publication that try to address this/these problem(s) are identified and discussed below.

One type of product is a light organ that is connected to a sound producing device and illuminates lights based upon the frequency of the sound that is being created. U.S. Pat. No. 3,163,077 issued on Oct. 23, 1961 for C. A. Shank and U.S. Pat. No. 4,000,679 issued on Jan. 4, 1977 for Richard E. Norman both disclose multiple channel color display apparatus. While these patent disclose light based upon a specific frequency the light are only on when the specific frequency is being heard or played into the color organ. These devices further require a high amount of power to operate.

Another type of device changes the electrical state of an electrical device when a loud or abrupt sound is heard. Typically this sound is a clap or other sound that turns on or off a device or emits an audible statement. Patents covered by this type of device are found in U.S. Pat. No. 5,615,271 that issued on Mar. 25, 1997 to Carlile R. Stevens et al and U.S. Pat. No. 6,417,773 that issued on Jul. 9, 2002 for Gust N. Vlahos et al. While these patents turn on or off an electrical device they are subject to continuous sounds that can unintentionally continue to turn the electrical device on and off.

Another type of a device is voice activated device that listens for a continuous repeated sound. The device requires a nearly continuous repeating sound that essentially blocks out other sounds to begin the activation process. In the case of U.S. Pat. No. 7,120,257 that issued on Oct. 10, 2006 to Charles R. Mahoney the sound is emitted from continuous shacking of a rattle that begins operation of a stuffed animal. While this patents cover activation to activate the toy the activation is with a sound that is louder or masks nearly all other sounds to operate the toy.

What is needed is a sound activated music accessory device that operates with music or other sounds that are embedded within the music or sound to synchronize light, vibration and or movement of the accessory device. The proposed sound activated music accessory device provides the solution to this problem.

### BRIEF SUMMARY OF THE INVENTION

It is an object of the sound activated music accessory device to be an accessory that operates with a movie or music. The accessory device further enhances the listening experience by providing an interaction device. The accessory device can be an item that is seen in the movie or music video and provides additional value to a consumer that views the movie or music video. The accessory product can be included with the CD/DVD or can be sold as a separate item. The CD/DVD can activate more than one device and a plurality of accessory devices can operate with the CD/DVD to provide different types of light, or motion where they can move separately or collectively.

It is an object of the sound activated music accessory device to sample the sound and or music from the movie or music to determine when to activate the accessory product. The activation and or deactivation are synchronized with the embedded sound that is placed into the soundtrack. The sound, tone, frequency or complex blended sound or sounds are subtle or non-obvious to a person listening to the music but are detected by the accessory device to begin a sequence or stop a sequence to correspond the a particular part of the soundtrack.

It is another object of the sound activated music accessory device for the activation to be lights and or vibration and or movement. The activation can mimic what is occurring in a movie, video or soundtrack. The audio track can further identify the activity or motion that is being performed by the accessory product such as, but not limited to flashing lights, vibrating or motion like clapping or moving a limb.

It is still another object of the sound activated music accessory device to be a bracelet, necklace, hat, headband, apparel, plush or rigid toy. Each of these different types of accessory products can be worn or used by a person or child that is watching or listening to a movie, song, soundtrack or television show.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a sound activated music accessory device as a bracelet.

FIG. 2 shows a second embodiment of the bracelet.

FIG. 3 shows the sound activated music accessory device as a headband.

FIG. 4 shows the sound activated music accessory device as a toucan.

FIG. 5 shows the sound activated music accessory device as a parrot.

FIG. 6 shows a child with sound activated music accessory devices of a toucan and a bracelet.

FIG. 7 shows a CD or DVD with the sound activated music accessory device.

FIG. 8 shows a block diagram of the components used in the sound activated music accessory device.

### DETAILED DESCRIPTION OF THE INVENTION

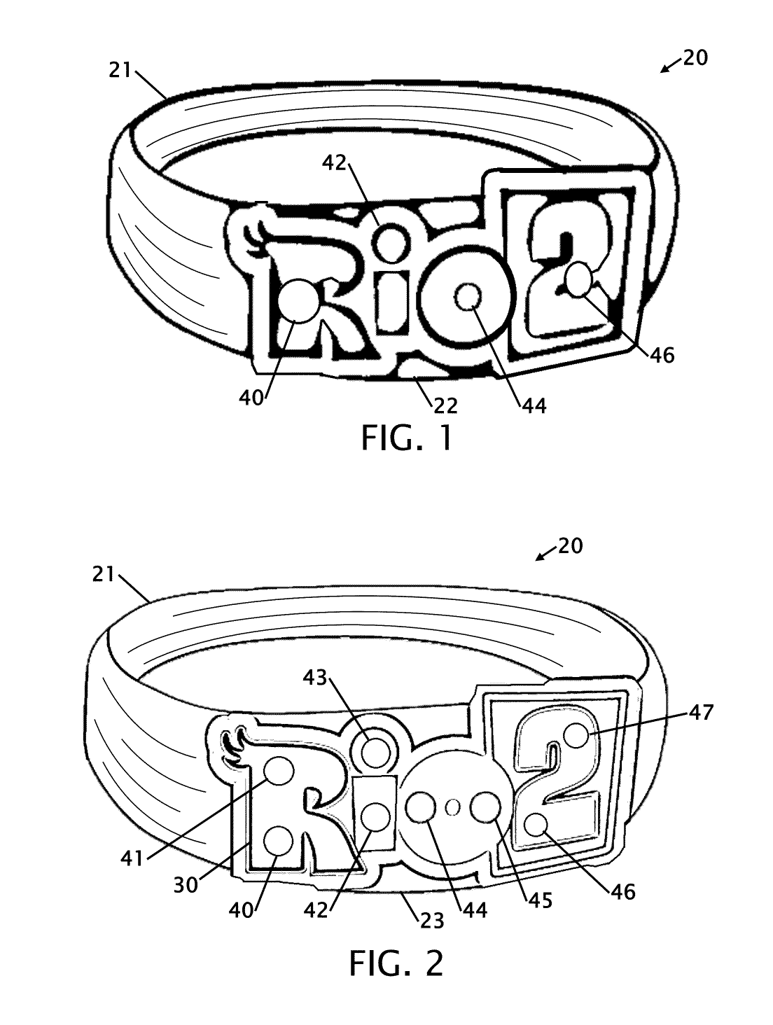

FIG. 1 shows a sound activated music accessory device as a bracelet 20 and FIG. 2 shows a second embodiment of the bracelet 20. In these preferred embodiments, the accessory device is a bracelet 20. The bracelet 20 takes a common shape that wraps around a wrist. The back 21 of the bracelet 20 is fabricated as from a flexible material that allows the bracelet 20 to stretch around a hand and then rebound to conform around a user wrist. While these embodiments show the bracelet 20 as a continuous ring, it is also contemplated that the bracelet 20 could be configured like a strap that is open and secured with a buckle. At least one side 22 and 23 of the bracelet 20 has lighting elements and can have a decoration as shown. In the embodiment shown in FIG. 1 there are four lighting elements 40, 42, 44 and 46 that have one light in each letter. In the embodiment shown in FIG. 2 there are two lighting elements 40-47 in each letter.

Once the bracelet 20 recognizes the start tone or sequence the lighting elements within the bracelet 20 will operate in a programmed sequence until the sequence times out or the bracelet 20 receives a recognizes a new command, a stop command or sufficient time has passed. While this embodiment shows a bracelet 20 the sound activated music accessory device can take nearly any shape or configuration, including but not limited to a bracelet, a necklace, a belt, a hoodie, an article of clothing, a headband, a plush toy and a rigid toy or device.

The sound activated music accessory device operates with music or soundtrack that and begins the entertainment sequence with an embedded sound that is not apparent from listening to the music or soundtrack. The embedded sound synchronizes lights, vibration, motion or sound with the actions or activities that are being played or shown from CD, DVD or movie. In another contemplated embodiment a person or child can purchase the sound activated music accessory device prior to watching a movie at a movie theater and can wear the sound activated music accessory device while they watch a movie. When the sound activated music accessory device detects the embedded sound(s) the sound activated music accessory device can begin the pre-programmed sequence(s). The internal operation is explained in more detail in FIG. 8.

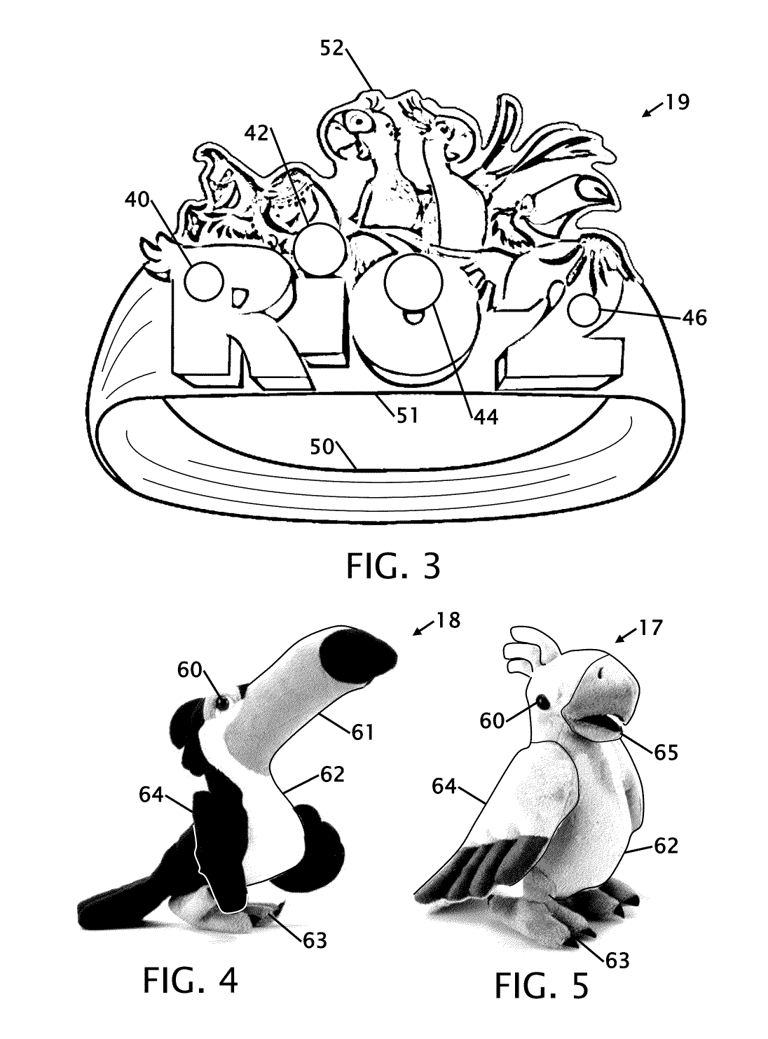

FIG. 3 shows the sound activated music accessory device as a headband 19. The headband 19 is shown as a more elaborate decoration with characters 52 from the soundtrack. The back 50 of the headband 19 extends behind the head of a user or child where the front 51 of the headband 19 has all or the predominant amount of decoration. The decoration 52 shows a particular set of decoration and characters from a particular movie or show, but can represent nearly any type of show or program for learning or entertainment. This embodiment shows four lights 40, 42, 44 and 46 as might be seen in FIG. 1. The lights extend through the outer surface of the headband 19, but could exist behind the surface where it illuminates parts, letters or portions of the decoration or letters to highlight particular elements of the bracelet, necklace or other sound activated music accessory device.

FIG. 4 shows the sound activated music accessory device as a toucan 18 and FIG. 5 shows the sound activated music accessory device as a parrot 17. These two figures could represent the real or animated actors, characters or figures. Using three-dimensional figures could be plush type toys or characters or hard figures. The use of free-standing FIGS. 17 and 18 provides additional space to add additional features, including but not limited to vibration, motion and sound. Vibration of the body 62 might be used with the figure is scared. Motion may be used for dancing or motion as might occur when the name of the character is called and the character nods, blinks an eye 60, opens their mouth/beak 61, 65 or moves a wing 64. The accessory 17, 18 can respond with a sound or spoken word when the embedded sound or noise is detected.

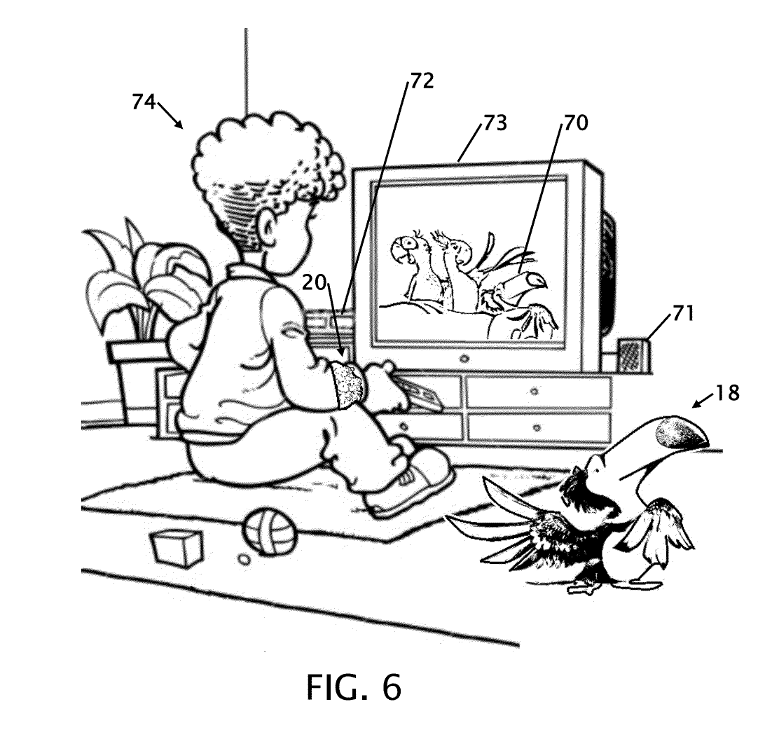

FIG. 6 shows a child with sound activated music accessory devices of a toucan 18 and a bracelet 20. In this figure a child 74 is shown viewing an image on a TV 73 while the listen to the story from the speakers 71. The image and sound is from a DVD being played from a player 72. While this shows a particular set of components, the child 74 may be watching and listening to a computer tablet where the visual and audio information is being delivered through a wireless connection. When the embedded acoustic sound is detected the bracelet 20 and or the figurine 18 will begin to respond with lights, and or vibration, and or movement, and or sound that further enhances the actions being shown or head from the DVD, CD or other program being viewed and heard. While this example shows and describes vision and audible content, the visual content is not required to operate the accessory product(s) and the accessory product can be activated by sound produced from a CD or MP3 player, radio or streaming sound signal. It is further contemplated that a live performance could also provide signal(s) for operation of the accessory product(s).

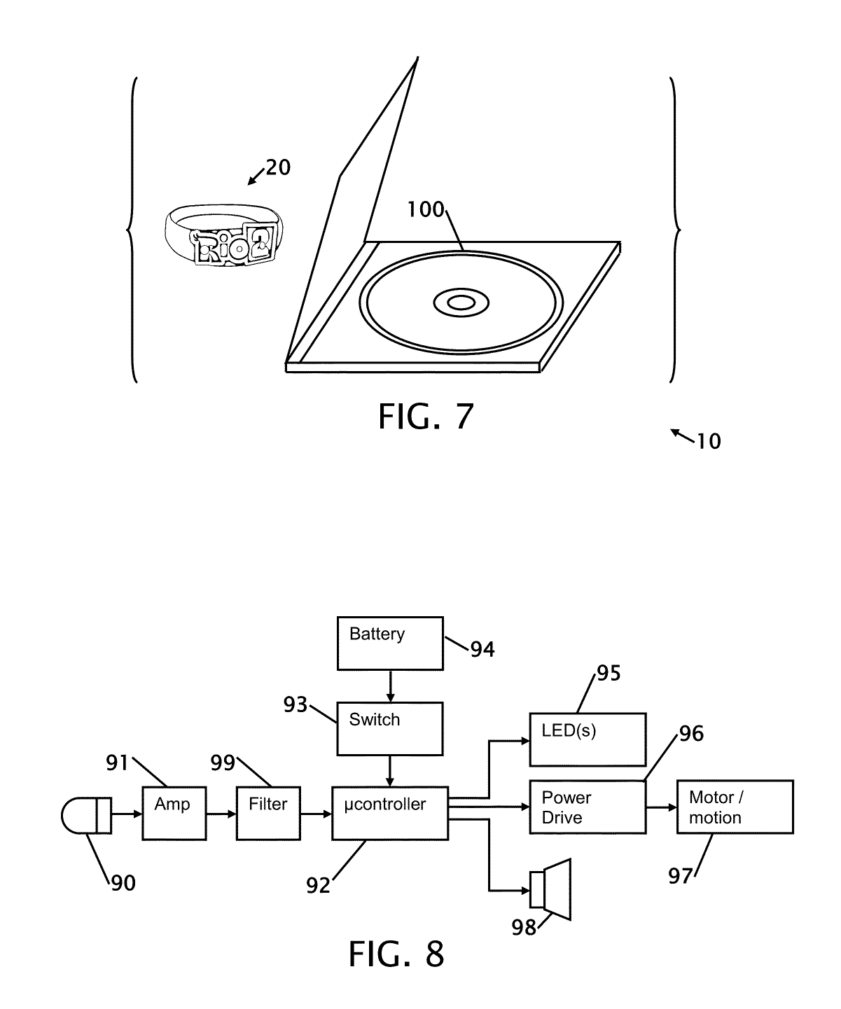

FIG. 7 shows a CD or DVD 100 with the sound activated music accessory device 20. This figure provides one contemplated delivery system for providing the accessory product 20 with the audio signal from a CD or DVD 100. While these playable items are discloses, it is contemplated that a consumer could purchase an accessory product prior to viewing a movie in a theater or other similar venue. An obvious variation would allow a person to purchase an accessory product prior to viewing the program with a rented DVD 100, or when the program is played through a cable box or similar device.

FIG. 8 shows a block diagram of the components used in the sound activated music accessory device. This basic block diagram shows one preferred embodiment where a microphone 90 or similar listening device receives audible signal. Typically the signal from a microphone 90 is small and must be amplified 91 to allow for further processing of the signal. A filter 99 can be used to identify particular frequencies or filter undesirable noise. The amplified signal is then processed by a microcontroller 92. The signal from the amplifier can go through other signal processing, DSP, filter or other type device to identify when an embedded start command is received. In another contemplated embodiment the audio track is monitored and when a particular audio track, sound combination and or passage matches as a sound finger print, the pre-defined sequence of sound, movement or lights operate on the accessory product. This can occur several times in when the audio match occurs. Different audio match patterns or finger prints can cause different actions from the accessory product.

The start command synchronizes the accessory product with the audio track being heard by the microphone 90. One or more embedded signals can be placed in the audio track to command one or multiple function. The embedded signal can be a specific frequency, a combination of frequencies played in a certain order or a complex dual tone. In general the embedded signal is between the audio range on between 20 Hz and 20K Hz, but more preferably in the range of 100 Hz and 10K Hz because the embedded signal can be fairly reliably generated by most speakers. In the use of dual tone commands or DTFM, each dual tone can have a different function and tones can cause the accessory product to perform a function at a future time when the audio track is silent.

The microcontroller 92 is shown connected through a switch 93 to a power source or battery 94. While a switch 93 is shown it is contemplated that the switch could be eliminated if a shorter life or lower power consumption allows. Upon detection of the embedded signal the microcontroller will operate one or more devices depending upon the configuration of the accessory device. In a basic accessory product LED(s) 95 are used to flash lights at the desired time and or sequence. It is also contemplated that a speaker 98 can be used to sing or play along with the soundtrack. Because most motors require higher power requirements a power drive 96 connects to a motor 97 for motion such as vibration, or moving a particular part of a plush or hard formed accessory or character as shown in FIGS. 4, 5 and 6. If the stop embedded is not detected the accessory device will stop the action after a pre-defined period of time. It desirable that the accessory product mimic, compliment or supplement the visual image or the audio sound being represented on the screen or in the audio track.

Thus, specific embodiments of a sound activated music accessory device have been disclosed. It should be apparent, however, to those skilled in the art that many more modifications besides those described are possible without departing from the inventive concepts herein. The inventive subject matter, therefore, is not to be restricted except in the spirit of the appended claims.

1. A sound activated music accessory device comprising:
a device having an audio detector;
said device having an action that activates at least one of a group consisting of a light, a vibrator, a motor and a speaker;
a soundtrack having at least one embedded audio signal, and
said audio detector listens to said soundtrack and uses said at least one embedded signal to synchronize said action.

2. The sound activated music accessory device according to claim 1 wherein said action is a pre-programmed sequence of actions.

3. The sound activated music accessory device according to claim 1 wherein said action continues until said audio detector detects a second embedded signal that stops said action.

4. The sound activated music accessory device according to claim 1 wherein said soundtrack further includes at least one visual image.

5. The sound activated music accessory device according to claim 4 wherein said sound activated music accessory device operates in unison with said at least one visual image.

6. The sound activated music accessory device according to claim 1 wherein said at least one embedded audio signal is a dual tone frequency modulation.

7. The sound activated music accessory device according to claim 1 wherein said at least one embedded audio signal sequences an action to occur when there is no audible audio track.

8. The sound activated music accessory device according to claim 1 wherein said sound activated music accessory device is a user wearable device.

9. The sound activated music accessory device according to claim 1 wherein aid sound activated music accessory device is a rigid or a plush toy.

10. The sound activated music accessory device according to claim 1 wherein said soundtrack is a movie or a song.

11. A sound activated music accessory device comprising:
a device having an audio detector;
said device having an action that activates at least one of a group consisting of a light, a vibrator, a motor and a speaker;
a soundtrack having a combination of audio sounds, and
said audio detector listens to said soundtrack and uses said at least combination of audio sounds to synchronize said action.

12. The sound activated music accessory device according to claim 11 wherein said action is a pre-programmed sequence of actions.

13. The sound activated music accessory device according to claim 11 wherein said action continues for a finite period of time based upon said combination of audio sounds.

14. The sound activated music accessory device according to claim 11 wherein said soundtrack further includes at least one visual image.

15. The sound activated music accessory device according to claim 14 wherein said sound activated music accessory device operates in unison with said at least one visual image.

16. The sound activated music accessory device according to claim 11 wherein said at least one embedded audio signal sequences an action to occur when there is no audible audio track.

17. The sound activated music accessory device according to claim 11 wherein said sound activated music accessory device is a user wearable device.

18. The sound activated music accessory device according to claim 11 wherein aid sound activated music accessory device is a rigid or a plush toy.

19. The sound activated music accessory device according to claim 11 wherein said soundtrack is a movie or a song.

20. The sound activated music accessory device according to claim 11 operates without an embedded signal and matches audio finger prints to activate said action.
